(19) United States
(12) Patent Application Publication
(10) Pub. No.: US 2011/0106649 A1
(43) Pub. Date: May 5, 2011

(54) Method and System for Ordering and Producing a Customized Product

(75) Inventor: Roberto Tagliabue, Lake Oswego, OR (US)

(73) Assignee: Uncommon LLC, Chicago, IL (US)

(21) Appl. No.: 12/855,410

(22) Filed: Aug. 12, 2010

Related U.S. Application Data
(60) Provisional application No. 61/233,147, filed on Aug. 12, 2009.

(51) Int. Cl. G06Q 30/00; H04W 88/02

(52) U.S. Cl. 705/26.5; 455/566

(57) ABSTRACT

A method and system is provided for ordering and producing customized merchandise such as, but not limited to, a protective cover for a portable electronic device. Generally speaking, the system for creating a customized product includes a cellular telephone having a display screen, an application for selecting an image to be printed onto a product, the application being loaded onto the cellular telephone, a server for storing the selected image to be printed on the product, the server being remotely accessible by the cellular telephone, and a printing device responsive to the server for printing the selected image on the product. A general method for creating a customized product includes the steps of loading an application to a cellular phone, wherein the application is executable by the cellular phone, executing the application through operation of the cellular phone, using the application to select an image to be printed onto a product, and printing the selected image on the product at a location remote from the cellular phone. The printing device is preferably a dye-sublimation printing device. Further, the selected image may be initially stored at one of either a remote server or on the cellular phone itself.

### RELATED APPLICATION

The present application claims the filing priority of, and incorporates herein by reference, Provisional Application No. 61/233,147, titled “Method And System For Ordering And Producing A Customized Product,” filed on Aug. 12, 2009.

### TECHNICAL FIELD

The present invention relates to order entry systems, and in particular to a system and method for ordering and producing customized merchandise such as, but not limited to, a protective cover for a portable electronic device.

### BACKGROUND OF THE INVENTION

Ordering products on-line has been a staple of the World economy for some time. Customization of products, if it can be called such, has been fairly limited to the selection of colors and occasionally has included a choice of materials. Customizing left little to the imagination of the consumer.

Further, for customizing products it has been necessary to have a computer and internet access or a designated kiosk. In the first instance, even with the prevalence of computers and free Wi-Fi Internet areas in stores, public buildings and restaurants, many people may not have access to secure computers for ordering products on-line. As for the use of a kiosk, such systems have little security or privacy and are only convenient if one is located in proximity to a consumer.

The invention of the present application addresses the need for a secure, private and convenient system for customizing and ordering products. The present invention overcomes these and many other problems associated with personalizing products, such as a protective case for an electronic device.

### SUMMARY OF THE INVENTION

There is disclosed herein an improved system and method for producing and ordering a customized product, such as a protective cover for a portable electronic device (e.g., a phone, camera, PDA, etc.) which avoids the disadvantages of prior devices while affording additional structural and operating advantages.

Generally speaking, embodiments of the system for creating a customized product comprise a cellular telephone having a display screen, an application for selecting an image to be printed onto a product, the application being loaded onto the cellular telephone, a server for storing the selected image to be printed on the product, the server being remotely accessible by the cellular telephone, and a printing device responsive to the server for printing the selected image on the product.

In an embodiment, the printing device is a dye-sublimation printing device. Further, the selected image may be initially stored at one of either a remote server or on the cellular phone itself.

As to a method for creating a customized product, embodiments generally comprise the steps of loading an application to a cellular phone, wherein the application is executable by the cellular phone, executing the application through operation of the cellular phone, using the application to select an image to be printed onto a product, and printing the selected image on the product at a location remote from the cellular phone.

These and other aspects of the invention can be more readily understood from a reading of the following detailed description accompanied by the appended drawing figures.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a simplified block diagram of a system in accordance with the present invention;

FIG. 2 is a partial simplified process flow diagram depicting a method of using the system of FIG. 1 wherein the process provides design selections comprising a seasonal collection gallery, a customize photo gallery and an artist collection gallery;

FIG. 3 is a simplified process flow diagram of the customized photo gallery that is provided by a user selecting the customize photo gallery selection of FIG. 2;

FIG. 4 is a simplified process flow diagram of the artist collection gallery that is provided by a user selecting the artist collection gallery selection of FIG. 2;

FIG. 5 is a simplified process flow diagram of various filters that can be applied to an image such as the photo taken in the process of FIG. 3;

FIG. 6 is a simplified process flow diagram of video image options that can be provided by the system of FIG. 1 via a video selection option provided by the process of FIG. 2; and,

FIGS. 7 and 8 are various screen shots of archived images that can be provided by the system of FIG. 1 via an archive selection option provided by the process of FIG. 2.

### DETAILED DESCRIPTION OF THE INVENTION

The following description of detailed embodiments is for exemplifying the principles and advantages of the invention. Unless otherwise stated herein, the following detailed description is not to be taken in any way as presenting limitations on the scope of the invention. Further, while the invention is largely described and shown in the appended drawings as a protective case for a phone, it should be understood that other such products, such as electronic protective and decorative cases, personal decorative items (e.g., jewelry), household items, novelty items, and much more, could provide the necessary product for customization in accordance with the invention of the present application.

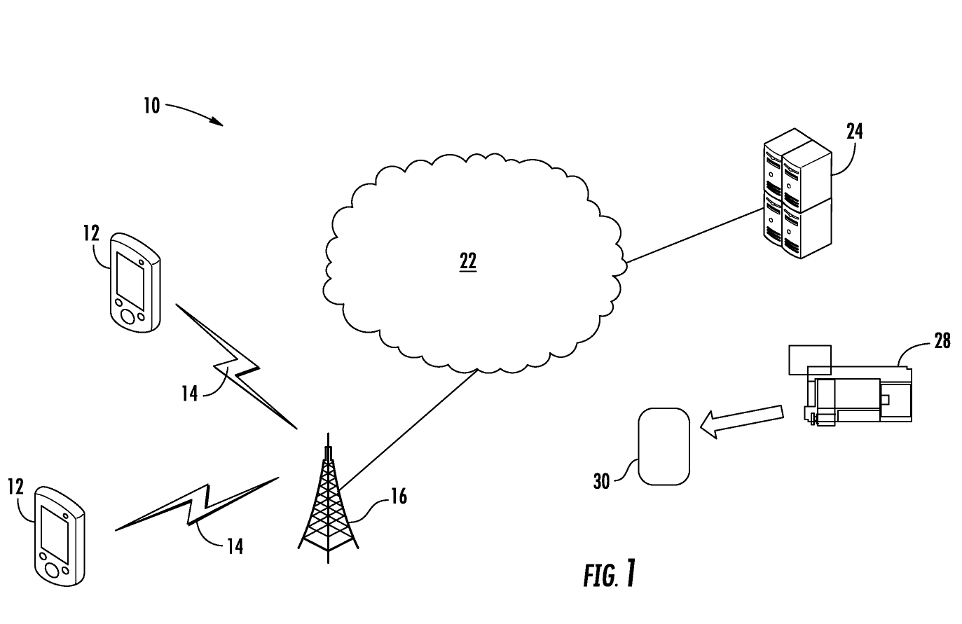

Turning to FIG. 1, a schematic for the general system and process for customized ordering and a product customization system in accordance with the present invention is depicted. Reference numbers used within FIG. 1 correspond to the following elements:

| Reference Number | Element |
|---|---|
| 10 | System |
| 12 | Cellular Telephone(s) |
| 14 | Bi-Directional Communication Link(s) |
| 16 | Cellular Telephone Base Station |
| 22 | Internet |
| 24 | Remote Server(s) |
| 28 | Product Imprinting Machine |
| 30 | Finished Product |

All other reference numbers used herein refer to components illustrated in the remaining drawing figures.

There is shown in FIG. 1 a system 10 in accordance with the present invention. The system 10 can include, but is not necessarily limited to, a plurality of conventional cellular telephones 12, each having a display that depicts ordering information provided by remote server(s) 24 via a conventional connection methodology comprising a conventional cellular communication link(s) 14, a conventional cellular telephone base station 16, and Internet 22.

The telephones 12 can be, for example, smart cellular telephones such as the IPHONE smart cellular telephone by Apple, Inc., Cupertino, Calif., the BLACKBERRY smart cellular telephone by Research in Motion, Ltd., Waterloo, Canada, and the DROID phone manufactured by Motorola, Inc., Schaumburg, Ill. As such, cellular telephone(s) 12 are conventional electronic devices for placing and receiving telephone calls over a conventional cellular telephone network. In addition, cellular telephone(s) 12 include conventional hardware and software for downloading and executing software applications on the telephone via remote server(s) 24.

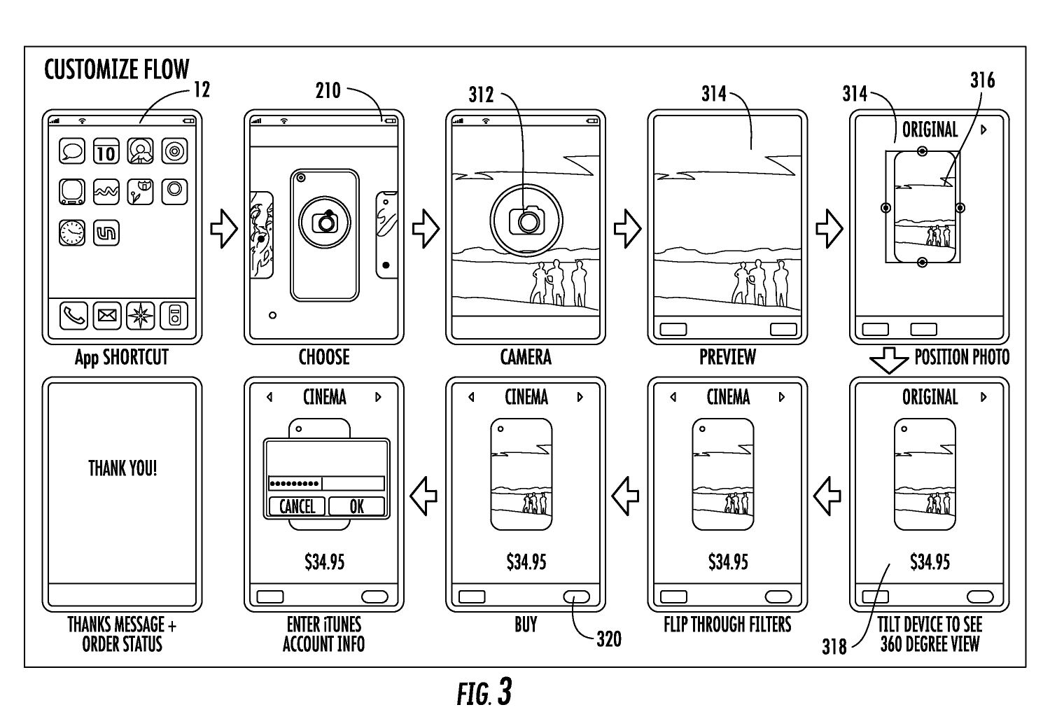

Turning to FIG. 3, the cellular telephone 12 has a software application loaded thereon in a conventional manner. The cellular telephone 12 also includes a conventional touch screen display or the like for selecting, and thus initiating execution of the software application via remote server(s) 24.

By executing the application, a main application screen 210 is provided on the display of the cellular telephone 12. The main screen 210 includes selection areas or objects 212 whereby a user can select in a conventional manner various options in ordering, and thus customizing, the offered product or merchandise. For example, a user can select options offered via a seasonal image collection gallery, an artist image collection gallery, or a customized photo gallery. In yet another embodiment, a user can also select from other galleries maintained on server(s) 24 (FIG. 1) such as a public gallery. For purposes of the present disclosure, such collections of images are considered databases.

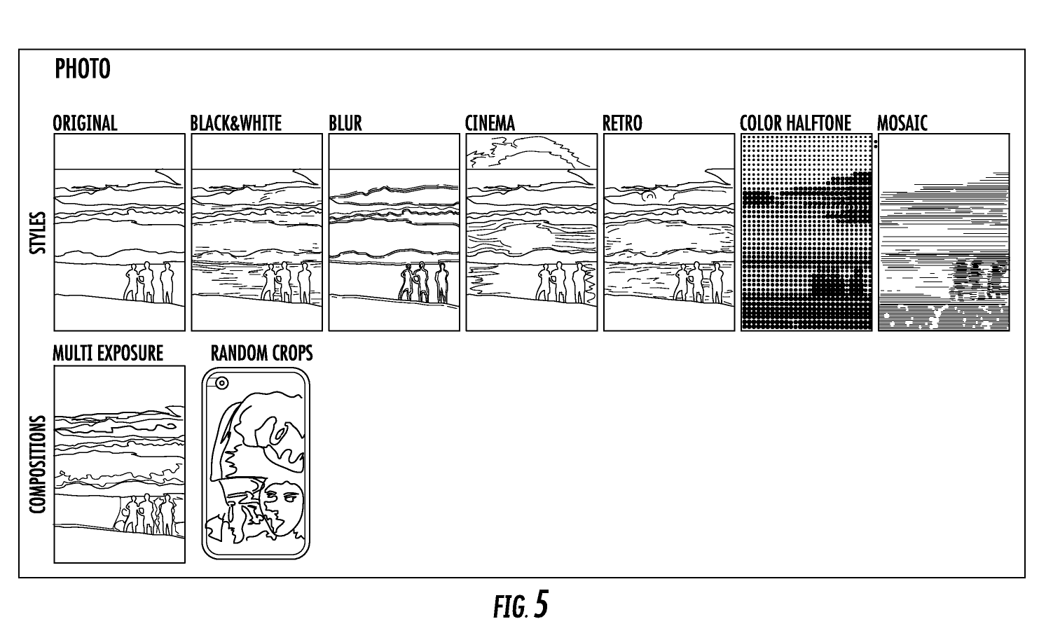

In FIG. 3, the customizing photo gallery selection process can begin by the application enabling a camera associated with the cellular telephone, whereby a user can take a picture by selecting an area 312 on the touch screen of the cellular telephone. Next, the user is offered, via the display, to preview the image taken 314 by the camera and position the photo on the merchandise or product to be ordered by sliding the image over a second image, that being of the merchandise itself or a reasonable representation thereof. The user may then be permitted to tilt a rendering 318 of the customized merchandise or product via tilt buttons or the like provided on the touch screen. In addition, the user can apply various filters to the image, such as those shown in FIG. 5, by selecting various buttons or the like provided on the touch screen. Once the user desires to purchase the customized merchandise, the user can select a button 320 for purchasing the item, wherein the user is provided with prompts for entering information to complete the purchase transaction.

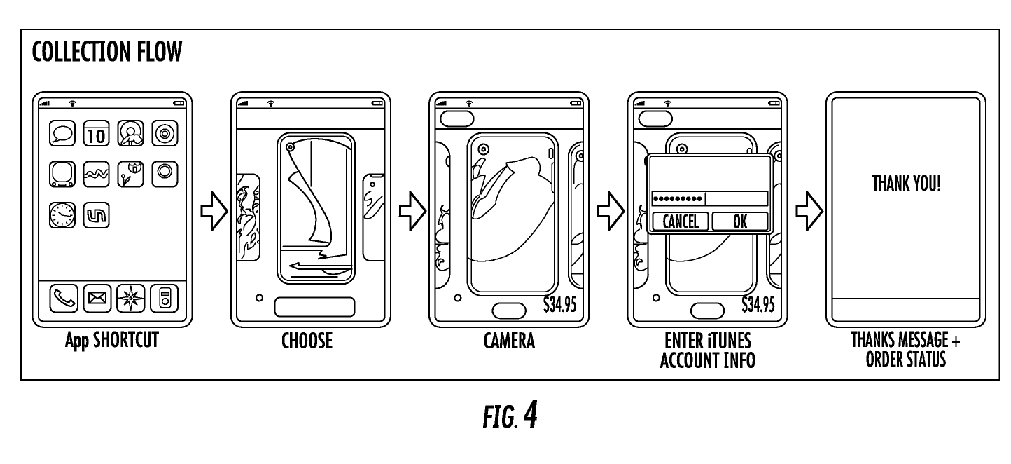

Turning to FIG. 4, the artist collection gallery selection can begin by the application providing images for a user to flip through images maintained on server(s) 24. Once the user finds an image to print on the merchandise or product, the user can select the image by touching a “button” for purchasing the customized item. In response, the application provides the user with prompts for entering information (e.g., payment and shipping information) to complete the transaction. The cellular telephone 12 may also have a stored collection of images from which a selection can be made and uploaded to the server(s) 24.

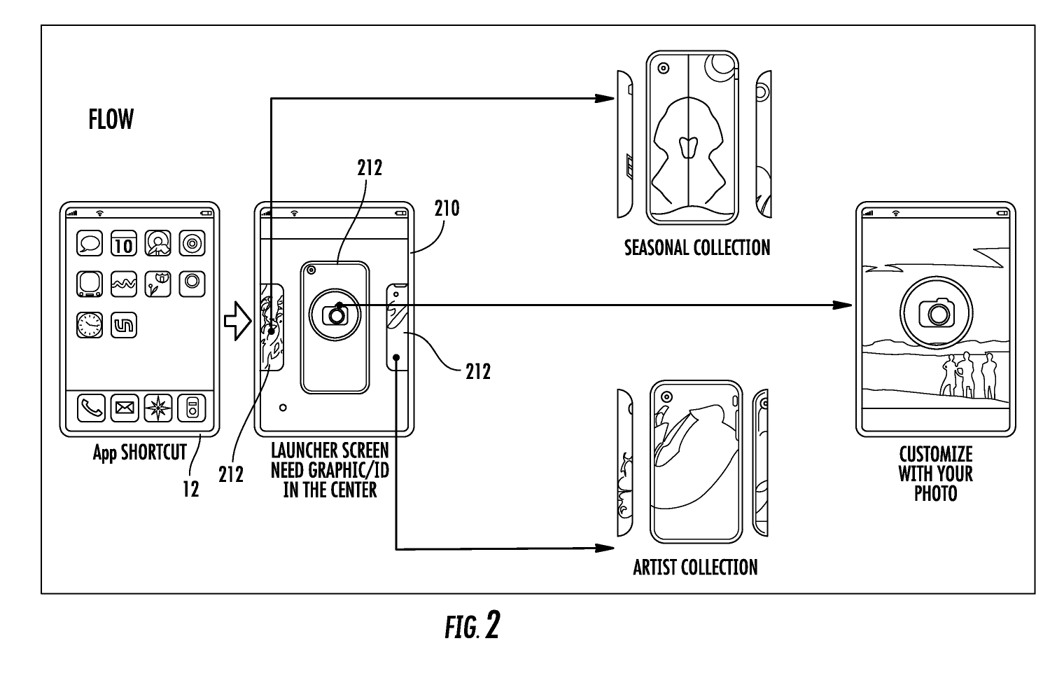

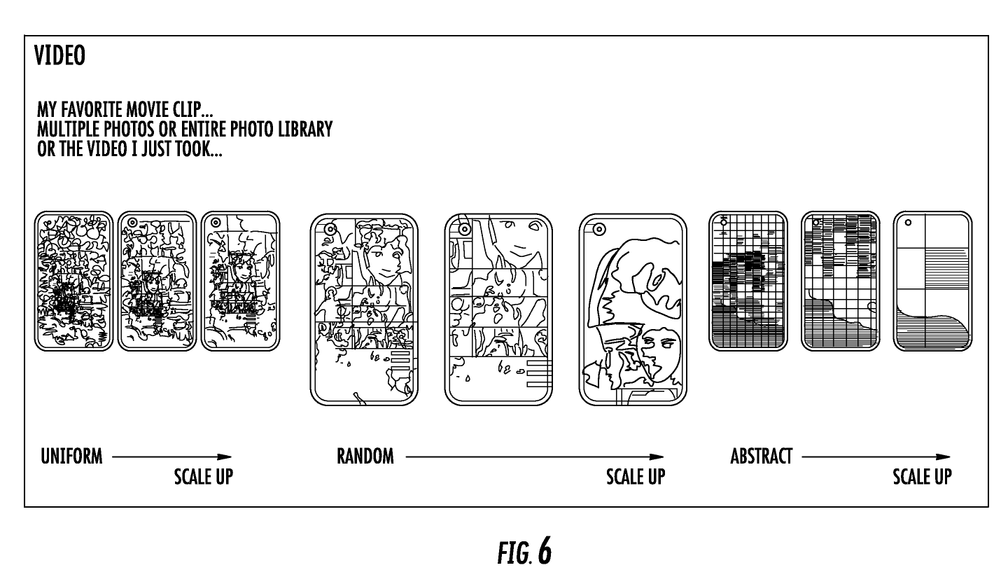

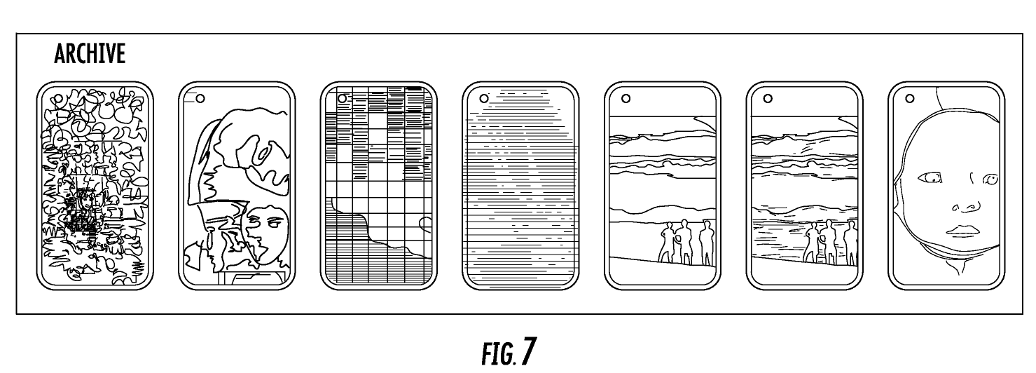

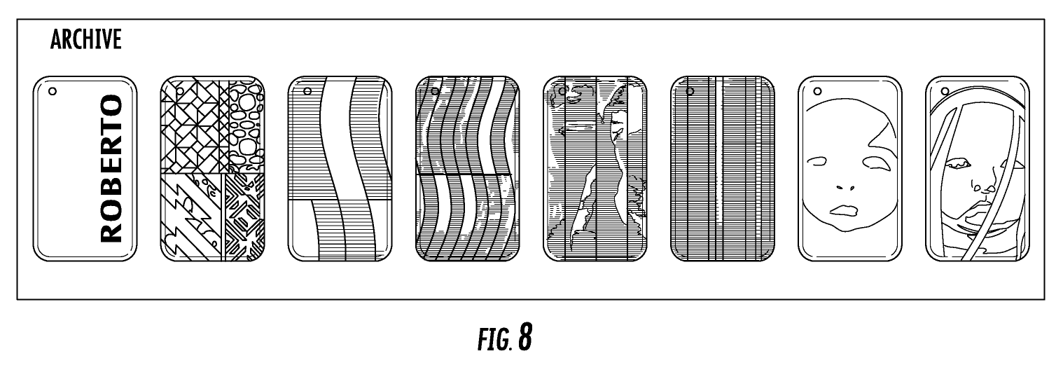

Returning to FIG. 2, a user can also be provided with a video selection and/or an archive selection. As shown in FIG. 6, the video selection can include options wherein a user records a video via the cellular telephone 12 or other recording means which might allow the video to be uploaded to the cellular telephone, and the user can then vary the frames of the video for printing on the merchandise or product. For instance, the size of each frame of the video can be modified wherein, via a slide bar or the like, the user can scale the size of each frame in the video, the sequence of the frames in the video can be changed and the clarity of image associated with the frames can be modified.

As previously indicated above, a user can also be provided with access to various archives of images (i.e., image databases) provided on servers 24 (FIG. 24) for selection and printing on the merchandise. The images of these archives can be categorized in any number of ways. For example, there may be image databases organized by themes, e.g., party, music, education, etc., or by main subject matter, e.g., images of dogs, images of cats, images of family, etc., or events, e.g., holidays, vacations, etc. and so on. Some images may be categorized in more than one database.

Returning to FIG. 1, the order placed by the user may then be stored on server(s) 24 and eventually downloaded for processing by an automated dye-sublimation printing machine to print the selected image onto the merchandise in a manner well-known by those of skill in the art and a process well-described in several U.S. and foreign patents and published applications, including U.S. Patent Publication Nos. 2008/0043288, 2007/0039682 and 2006/0028531, each incorporated herein by reference. In an embodiment, the merchandise or product can be a protective case for a cellular telephone such as that shown and described in co-pending application Ser. No. 12/855,311, titled “Two-Piece Protective Carrying Case” filed concurrently with the present application and assigned to the Assignee of present application, the disclosure of which is incorporated herein by reference. Thus, in this embodiment, the finished customized product 30 is a case or cover for a cellular telephone with the selected image printed thereon.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. A system for creating a customized product comprising:
a cellular telephone having a display screen;
an application for selecting an image to be printed onto a product, the application being loaded onto the cellular telephone;
a server for storing the selected image to be printed on the product, the server being remotely accessible by the cellular telephone; and
a printing device responsive to the server for printing the selected image on the product.

2. The system of claim 1, wherein the product is a protective cover for a portable electronic device.

3. The system of claim 1, wherein the product is a protective cover for a non-electronic device.

4. The system of claim 3, wherein the product is a personal decorative accessory.

5. The system of claim 4, wherein the personal decorative accessory is jewelry.

6. The system of claim 5, wherein the jewelry is a bracelet.

7. The system of claim 1, further comprising an image database stored on the server, the image being selected from the image database.

8. The system of claim 1, further comprising an image database stored on the Internet, the image being selected from the image database.

9. The system of claim 1, further comprising an image database stored on the cellular phone, the image being selected from the image database.

10. The system of claim 1, wherein the printing device is a sublimation printing device.

11. A method for creating a customized product, the method comprising the steps of:
loading an application to a cellular phone, wherein the application is executable by the cellular phone;
executing the application through operation of the cellular phone;
using the application to select an image to be printed onto a product; and
printing the selected image on the product at a location remote from the cellular phone.

12. The method of claim 11, further comprising the step of accessing an image database from the cellular phone before selecting an image to be printed, wherein the image is selected from the image database.

13. The method of claim 12, wherein the image database is stored on the Internet.

14. The method of claim 12, wherein the image database is stored on a remote server.

15. The method of claim 12, wherein the image database is stored on the cellular phone.

16. The method of claim 11, further comprising the step of selecting a product to customize before the step of using the application to select an image.

17. The method of claim 11, wherein the product is a protective cover for an electronic device.

18. The method of claim 11, wherein the product is a decorative personal item.

19. The method of 11, further comprising the step of manipulating the selected image to create a personalized image, and the step of printing the selected image comprises the step of printing the personalized image.

20. The method of claim 19, wherein the step of manipulating the selected image comprises the step of using at least one image editing tool selected from the group consisting of cropping, stretching, rotating, filtering, coloring, scaling, morphing and any combination thereof.

21. The method of claim 11, wherein the step of printing the image comprises sublimation printing.
